(19) United States
(12) Patent Application Publication
(10) Pub. No.: US 2025/0357816 A1
(43) Pub. Date: Nov. 20, 2025

(54) CONNECTION DEVICES FOR A STATOR OF AN ELECTRIC MACHINE, STATOR DEVICE FOR AN ELECTRIC MACHINE, AND ELECTRIC DRIVE FOR A VEHICLE

(71) Applicant: VALEO EAUTOMOTIVE GERMANY GMBH, Erlangen (DE)

(72) Inventors: Christian FINGER-ALBERT, Erlangen (DE); Kay LEMMERT, Erlangen (DE); Stephan HELLMUTH, Bad Neustadt a.d. Saale (DE)

(73) Assignee: VALEO EAUTOMOTIVE GERMANY GMBH, Erlangen (DE)

(21) Appl. No.: 18/871,690

(22) PCT Filed: Jun. 27, 2023
(86) PCT No.: PCT/EP2023/067380

§ 371 Date: Dec. 4, 2024

(30) Foreign Application Priority Data
Jun. 28, 2022 (EP) 22181702.6

(51) Int. Cl. H02K 3/50; B60L 15/00

(52) U.S. Cl. CPC H02K 3/50; B60L 15/007; H02K 2203/09

(57) ABSTRACT

A stator device for an electric machine includes a stator, having a stator core with a longitudinal axis, a first end face and a second end face which is situated axially opposite the first end face with respect to the longitudinal axis, and having a stator winding which forms a winding head on the first end face and has a plurality of connection portions extending beyond the winding head. The isolating body has a plurality of holding elements, which protrude from the base portion on the second side and are designed to hold the isolating body radially on the winding head.

The invention relates to a stator device for an electric machine and to an electric drive for a vehicle.

Connection devices are regularly used to connect a stator winding of a stator to a voltage source to power the stator winding. Such connection devices may be arranged in the region of a winding head.

US 2013/0147306 A1, for example, discloses a spacer for supporting conductors of a stator assembly of an electric machine. The spacer comprises an isolating body made of an electrically non-conductive material. Phase guide slots for receiving phase conductors are formed in the isolating body. Lugs for connecting the phase conductors are arranged at the end of a respective phase conductor. The isolating body rests axially on the winding head.

However, the winding head may be irregularly shaped due to unavoidable manufacturing tolerances, making it difficult to accurately position the connection device on the winding head. This is a hinderance particularly with regard to automated manufacture of the stator device.

The invention is based on the object of providing an improved option, in particular an option that facilitates automated manufacture, for the arrangement of a connection device in the region of a winding head of a stator.

This object is achieved according to the invention by a stator device for an electric machine, having: a stator, having a stator core with a longitudinal axis, a first end face and a second end face which is situated axially opposite the first end face with respect to the longitudinal axis, and having a stator winding which forms a winding head on the first end face and has a plurality of connection portions extending beyond the winding head; and a connection device which has an isolating body which has a plate-shaped base portion with a first side remote from the winding head and a second side facing the winding head and is designed to connect the connection portions to an electrical conductor; wherein the isolating body has a plurality of holding elements which protrude from the base portion on the second side and are designed to hold the isolating body radially on the winding head.

The stator device according to the invention for an electric machine has a stator. The stator has a stator core. The stator core has a longitudinal axis, a first end face and a second end face. The second end face is situated axially opposite the first end face with respect to the longitudinal axis. The stator furthermore has a stator winding. The stator winding forms a winding head on the first end face. The stator winding has a plurality of connection portions extending beyond the winding head. The stator device according to the invention also has a connection device. The connection device has an isolating body. The isolating body has a plate-shaped base portion. The base portion has a first side. The first side is remote from the winding head. The base portion also has a second side. The second side faces the winding head. The connection device is designed to connect the connection portions to an electrical conductor. The isolating body has a plurality of holding elements. The holding elements protrude from the base portion on the second side. The holding elements are designed to hold the isolating body radially on the winding head.

The invention is based on the consideration of specifying the position of the connection device by means of the holding elements on the winding head. In particular, radial and/or axial slipping of the connection device during manufacture can thus be prevented. In addition, a radial bracket of the connection device on the winding head is less susceptible to manufacturing tolerances of the stator winding or the winding head thereof. Compared to conventional connection devices which are shaped for direct axial arrangement on the winding head, the stator device according to the invention is more robust with respect to manufacturing tolerances, which simplifies the automated manufacture of the stator device considerably.

In a preferred configuration, the isolating body is formed from a plastic. The base portion is preferably ring-sector-shaped so that it extends around the longitudinal axis.

The stator winding is preferably formed of a plurality of shaped conductors, one of which forms the connection portion. The shaped conductors are preferably formed of bent metal rods, preferably metal rods which have been bent multiple times. Such a stator winding may also be referred to as a hair pin winding.

In a preferred configuration of the stator device according to the invention, the holding elements comprise holding elements of a first type which are elastically deformable at least in sections such that they exert a restoring force for holding the isolating body on the winding head. This enables the connection device to be easily clamped radially to the winding head.

In addition, the holding elements comprise holding elements of a second type which are designed to absorb a counterforce of the restoring force. The holding elements of the first and second type are preferably arranged on opposite radial sides of the winding head. Provision is preferably made for the holding elements of the first type to be arranged radially inside the winding head and for the holding elements of the second type to be arranged radially outside the winding head. However, it is also possible for the holding elements of the first type to be arranged radially outside the winding head and for the holding elements of the second type to be arranged radially inside the winding head.

The holding elements of the first type preferably each have a frame and elastically deformable tabs formed within the frame. The tabs may be mounted on the frame and exert the restoring force on the winding head.

In the stator device according to the invention, provision is also preferably made for a plurality of legs which rest on the stator core and position the base portion at a distance from the stator to be arranged on the second side of the base portion. As a result, the connection device is positioned on the stator with respect to an axial direction.

Provision may also be made in the stator device according to the invention for the base portion to have a plurality of passage openings through which the connection portions are passed.

In addition, it is preferred if the connection device has a star point conductor and the isolating body has guide elements by way of which a movement of the star point conductor along the longitudinal direction thereof and/or transversely to the longitudinal direction thereof is able to be impeded. The star point conductor may be electrically conductively and mechanically connected to further connection portions of the stator winding. In addition, the base portion of the isolating body may have further passage openings through which the further connection portions which are connected to the star point conductor are passed.

In a preferred development, the connection device also has: an electrically isolating second isolating body which has a plate-shaped base portion with a first side and a second side which is situated opposite the first side and facing the first side of the base portion of the first isolating body, and an electrically conductive connection element which has a securing means for electrically conductive and mechanical connection to the electrical conductor and is arranged on the first side of the second isolating body.

The second isolating body is preferably formed from plastic. It may also be formed in a ring-sector shape around the longitudinal axis.

In a development, provision may be made for the connection element to have two limb portions and a connection portion which connects the two limb portions at least in sections, wherein two connection portions of the stator winding are electrically conductively and mechanically connected to each of the limb portions of one of the connection elements in order to form an electrically conductive connection of the connection portions to the electrical conductor via the connection element. The limb portions preferably extend parallel to the longitudinal axis. The connecting portion may extend from one limb portion to the other limb portion in a plane perpendicular to the longitudinal axis.

The base portion of the second isolating body may also have a recess in which the two connection portions are arranged. The recess is preferably formed on the edge side of the base portion. The recess is preferably open and/or provided at an edge of the base portion of the second isolating body which is situated radially remote from the longitudinal axis.

A projection facing the recess may also be formed on a respective limb portion. The projection may protrude radially from the limb portion, in particular pointing away from the longitudinal axis. The connection portions are preferably electrically conductively and mechanically secured to the projections, in particular by welding.

As an alternative or in addition, the base portion of the first isolating body has passage openings through which the two connection portions are passed from the winding head to the connection element.

The connection element is preferably a busbar which has been bent multiple times. The connection element preferably has a U profile. The busbar may have a rectangular cross section with a narrow side and a wide side along its direction of extent from one of the limb portions over the connecting portion to the other of the limb portions. The projection preferably protrudes from one of the narrow sides.

Provision may also be made for the base portion of the second isolating body to have a positioning portion arranged on the first side and for the connection element to be arranged on the second isolating body by the positioning portion.

This enables the position of the connection element on the first side of the base portion of the second isolating body to be ensured by the positioning portion. The projections of the connection element may thus be arranged precisely with respect to the recess in order to guide the connection portions of the stator winding through the recess to the projections. This enables an exact arrangement of the connection portions with respect to the projections, which further facilitates the automated manufacture of the stator device.

A plurality of positioning portions, in particular a number of positioning portions corresponding to the number of phases of the stator winding, and one connection element and one recess for each positioning portion are preferably provided.

In a preferred configuration of the connection device according to the invention, the securing means has an internal thread. This means that the electrical conductor can be mechanically robustly secured to the securing means and thus to the connection element.

As an alternative or in addition, a passage opening may be formed in the connecting portion, into which the securing means is pressed. In this case, the connection element is formed in multiple parts. However, it is also possible that the securing means is formed in one piece with the connecting portion.

The securing means may be formed as a bushing which extends from the connecting portion into an intermediate space delimited by the limb portions. The positioning portion may then be operatively connected to the bushing for positioning the connection element within the intermediate space.

The positioning portion preferably has a centering element formed on the first side, with at least sections thereof being formed in a mirror-inverted manner to the bushing. The centering element preferably surrounds the bushing in sections in order to specify a relative position of the connection element with respect to the second isolating body or the base portion thereof.

In a preferred configuration, provision is also made for the positioning portion to have a delimiting element extending from one of the limb portions to the other of the limb portions, by way of which a translational movement of the connection element parallel to the base portion is inhibited. The delimiting element preferably extends between the limb portions. The centering element may be formed in sections as an indentation of the delimiting element.

In a preferred development, provision is made for the positioning portion to have at least one stop for at least one limb portion of the connection element positioned by said positioning element, said stop being arranged outside the limb portions and being able to inhibit a rotation of the connection element about a rotational axis perpendicular to the base portion and/or being able to inhibit a translational movement of the connection element parallel to the base portion of the second isolating body. Two respective stops are particularly preferably provided on the outside of each limb portion.

The isolating body may also have shielding elements which surround the connection element on the limb portion side for extending air and creepage distances. The shielding elements preferably extend further away from the first side than the connecting element, in particular in the axial direction. In a preferred configuration, the at least one stop is arranged on the shielding element and/or formed in one piece with the shielding element. The stop may protrude perpendicularly from the shielding element.

According to a particularly preferred configuration, provision is made for the positioning portion to have for each limb portion of the connection element positioned by said positioning portion a holding element by way of which a movement of the connection element away from the first side is able to be inhibited. In particular, the holding element is designed to hold the connection element on the isolating body. The holding element may be arranged between the limb portions.

In a development, provision may be made for the limb portions to each have a recess and for the holding element to be designed for positive engagement in the recess. A latching connection is particularly preferred due to the recess and the holding elements.

In addition, provision may be made for the holding member to be arranged eccentrically with respect to the limb portion in order to inhibit interaction of the limb portion with the holding element in an arrangement rotated by 180°. In other words, eccentric arrangement can provide an anti-rotation action when the connection element is positioned on the second isolating body. This can advantageously prevent incorrect positioning of the connecting element, since a worker immediately notices a faulty arrangement, that is to say an arrangement rotated by 180°, due to the incompatibility of the holding element and arrangements in this position.

In addition, the first isolating body may have a plurality of securing portions which protrude from the base portion of the first isolating body in the direction facing the first isolating body and are designed to secure the second isolating body to the first isolating body. In this case, at least some of the securing portions may be in the form of a latching element which penetrates a passage opening of the base portion of the second isolating body and engages behind the base portion of the second isolating body in order to secure same on the first side thereof. As an alternative or in addition, provision is made for at least some of the securing portions to engage with a securing means, in particular a screw, which penetrates the base portion of the second isolating body.

The object on which the invention is based is further achieved by an electric drive for a vehicle, having: a stator device according to the invention, a rotor mounted so as to be able to rotate with respect to the stator device such that the stator device and the rotor form an electric machine, a converter for the electrical power supply of the stator winding and the electrical conductor via which the converter is electrically conductively connected to the connection portion.

Further advantages and details of the present invention can be found in the exemplary embodiments described below and on the basis of the drawings. These drawings are schematic illustrations, in which:

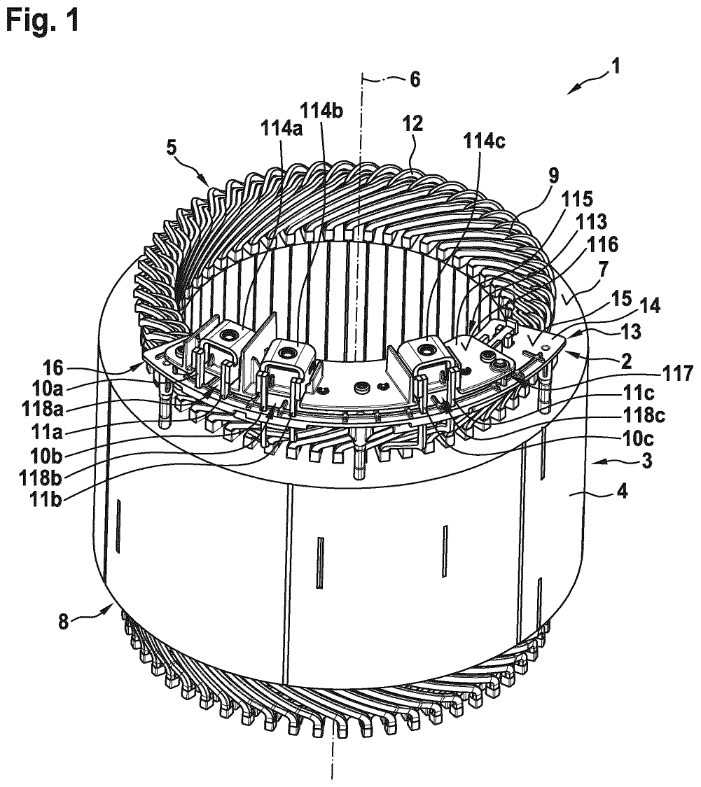

FIG. 1 shows a perspective view of an exemplary embodiment of the stator device according to the invention;

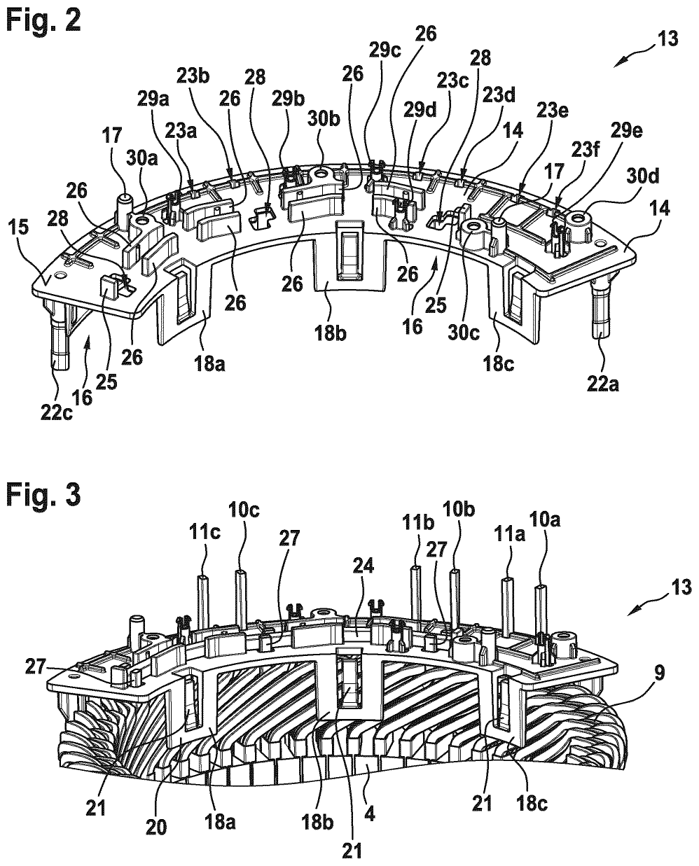

FIG. 2 shows a perspective view of the first isolating body;

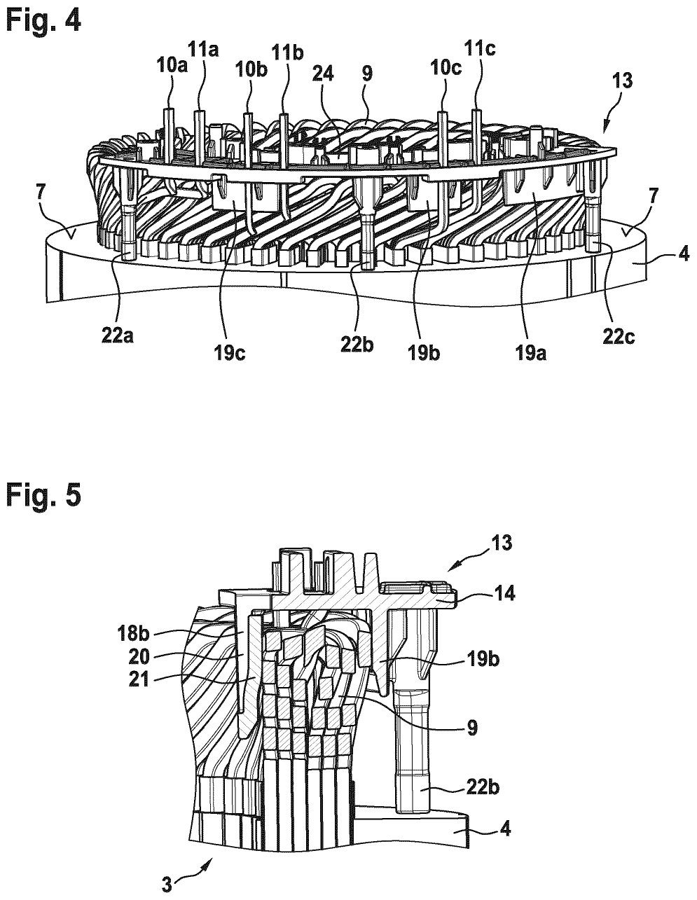

FIGS. 3 and 4 each show a detailed perspective view of the stator and the first isolating body;

FIG. 5 shows a cutaway view of the stator and the first isolating body;

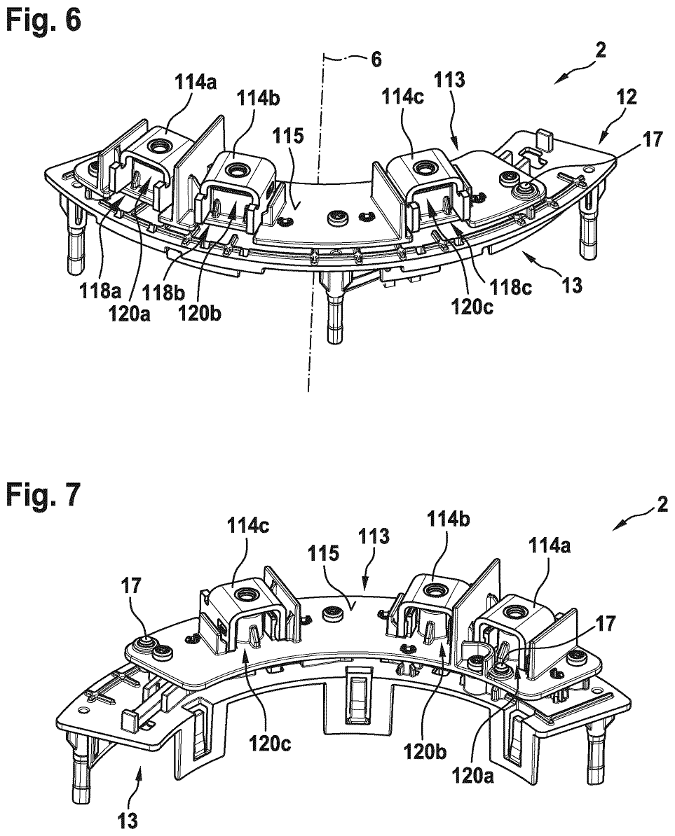

FIGS. 6 and 7 show a perspective view of the connection device;

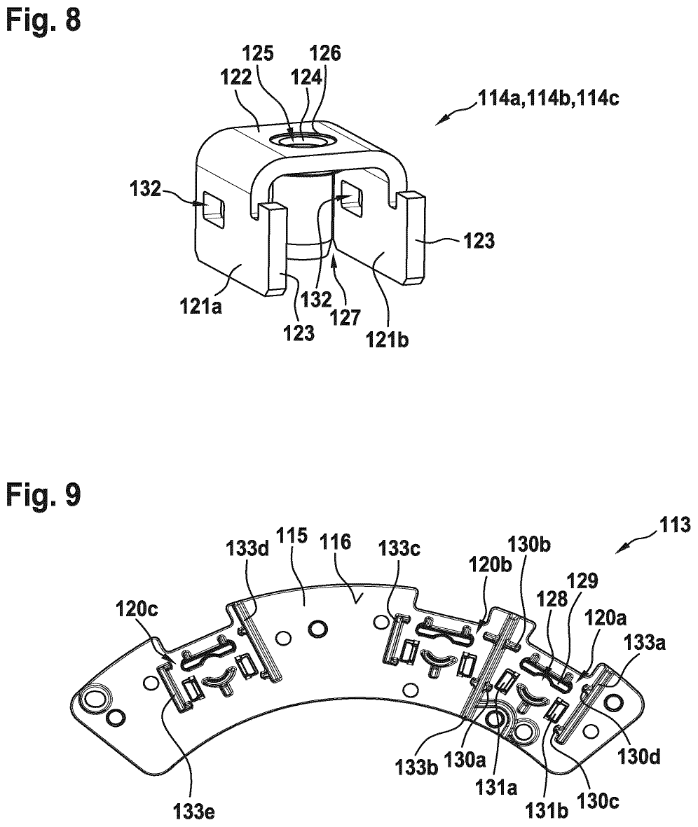

FIG. 8 shows a perspective view of a connection element;

FIG. 9 shows a top view of the second isolating body;

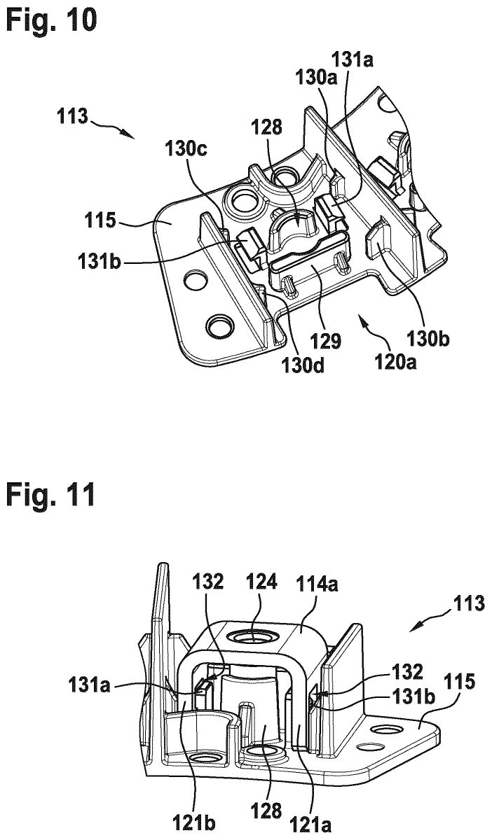

FIG. 10 shows a detailed perspective view of the second isolating body;

FIG. 11 shows a detailed perspective view of the second isolating body with the connection element arranged; and

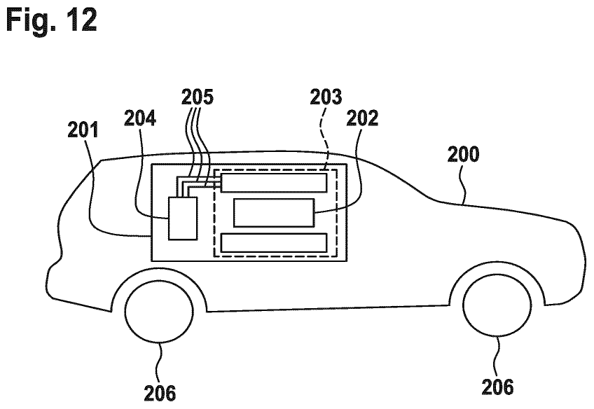

FIG. 12 shows a diagram of a vehicle having an exemplary embodiment of the electric drive according to the invention.

FIG. 1 is a perspective view of an exemplary embodiment of a stator device 1 with a connection device 2.

In addition to the connection device 2, the stator device 1 has a stator 3 with a stator core 4 and a stator winding 5.

The stator core 4 has a longitudinal axis 6, a first end face 7 and a second end face 8 which is situated opposite the first end face 7. As an example, the stator core 4 is formed from a plurality of individual laminations (not shown) which are arranged in axial layers and are electrically insulated from one another and may therefore also be referred to as a stator laminated core.

The stator winding 5 forms a winding head 9 on the first end face 7 and has a plurality of connection portions 10a, 11b, 10c, 11a, 10b, 11c on the first end face 7. In the present exemplary embodiment, the stator winding 5 is formed from a plurality of shaped conductors 12 which each extend axially through the stator core 4 and are electrically conductively and mechanically connected, for example welded, to one another on the second end face 8. The stator winding 5 may therefore also be considered as a hair pin winding.

The connection device 2 also has a first isolating body 13. The first isolating body 13 has a plate-shaped base portion 14 with a first side 15 facing away from the winding head 9 and a second side 16 facing the winding head 9. The base portion 14 is ring-sector-shaped and extends around the longitudinal axis 6.

FIG. 2 to FIG. 5 each show the first isolating body 13, wherein FIG. 2 is a perspective view of the first isolating body 13, FIG. 3 and FIG. 4 are each a perspective view of the stator 3 and the first isolating body 13 and FIG. 5 is a cutaway view of the stator 3 and the first isolating body 13.

The first isolating body 13 has a plurality of holding elements 18a, 18b, 18c, 19a, 19b, 19c which are designed to hold the first isolating body 13 on the winding head 9. The holding elements 18a-c, 19a-c are arranged on the second side 16 of the base portion 14 and protrude from the base portion 14 in the direction facing the stator core 4.

The holding elements 18a-c, 19a-c comprise holding elements of a first type 18a-c and holding elements 19a-c of a second type. The holding elements of the first type 18a-c are elastically deformable in sections such that they exert a restoring force for holding the first isolating body 13. The holding elements of the second type 19a-c are designed to absorb a counterforce of the restoring force. To this end, the holding elements of the first type 18a-c and the holding elements of the second type 19a-c are arranged on opposite radial sides of the winding head 9. In the present exemplary embodiment, the holding elements of the first type 18a-c are arranged radially inside the winding head 9 and the holding elements of the second type 19a-c are arranged radially outside the winding head 9. As an alternative, however, the holding elements of the first type 18a-c may also be arranged radially outside the winding head 9 and the holding elements of the second type 19a-c are arranged radially inside the winding head 9.

In detail, the holding elements of the first type 18a-c each have a frame 20 and elastically deformable tabs 21 formed within the frame. The tabs 21 are mounted on the frame 20 and exert the restoring force on the winding head 9.

The first isolating body 13 also has three legs 22a, 22b, 22c. The legs 22a-c are formed on the second side 16 and rest on the first end face 7 of the stator core 4. The limbs 22a-c thus space the base portion 14 apart from the first end face 7.

Furthermore, the base portion 14 has one passage opening 23a, 23b, 23c, 23d, 23e, 23f for each connection portion 10a-c, 11a-c (see FIG. 2). Each of the connection portions 10a-c, 11a-c penetrates one of the passage openings 23a-f.

As is best seen in FIG. 2 and FIG. 3, the connection device 2 also has a star point conductor 24 formed as a busbar. The star point conductor 24 is arranged in a plurality of guide elements 25, 26 which are arranged protruding from the first side 15 of the base portion 14 of the first isolating body 13. In this case, a movement of the star point conductor 24 along the longitudinal direction thereof or in the circumferential direction with respect to the longitudinal axis 6 is able to be inhibited by the guide elements 25 and a movement of the star point conductor 24 transversely to the longitudinal direction thereof or in the radial direction with respect to the longitudinal axis 6 is able to be inhibited by the guide elements 26. The star point conductor 24 is electrically conductively and mechanically connected to further connection portions 27 of the stator winding 5. For each further connection portion 27, a further passage opening 28 (see FIG. 2) is formed in the base portion of the first isolating body 13.

Again with reference to FIG. 1, the connection device 2 also has an electrically isolating second isolating body 113 and three electrically conductive connection elements 114a, 114b, 114c. The second isolating body 113 has a plate-shaped base portion 115 with a first side 116 and a second side 117 which is situated opposite the first side. The second side 117 is facing the first end face 7 of the stator core 4 and the winding head 9.

The base portion 115 has one recess 118a, 118b, 118c for each connection element 114a-c. Two of the connection portions 10a-c, 11a-c can be arranged in each of the recesses 118a-c, e. The two connection portions 10a-c, 11a-c are mechanically and electrically conductively connected, for example by welding, to one of the connection elements 114a-c. In this case, the two connecting portions 10a-c, 11a-c connected by one of the connection elements 114a-c are each assigned to one phase of the stator winding 5. In the present exemplary embodiment, the base portion 14 is for example ring-sector-shaped and extends around the longitudinal axis 6. Each of the connection portions 10a-c, 11a-c clearly penetrates one of the passage openings 23a-f of the first isolating body 13 such that in each case one pair of the connection portions 10a-c, 11a-c are guided into the recesses 118a-c of the base portion 115 of the second isolating body 113 respectively.

FIG. 6 and FIG. 7 each show a perspective view of the connection device 2. FIG. 8 is a perspective view of a connection element 114a-c.

On the first side 116, the second isolating body 113 has for each connecting member 114a-c a positioning portion 120a, 120b, 120c by way of which the connection element 114a-c is arranged on the second isolating body 113. The connection elements 114a-c each have two limb portions 121a, 121b which extend away from the first side 116. In the present case of the ring-sector-shaped base portion 115, the limb portions 121a, 121b thus extend in the axial direction with respect to the longitudinal axis 6. In addition, each connection element 114a-c has a connecting portion 122 which connects the limb portions 121a, 121b at its end facing away from the first side 116.

Each limb portion 121a, 121b has a projection 123 facing the recess 118a-c. Referring to the longitudinal axis 6, the projections 123 extend radially outward. As can be seen when viewed together with FIG. 1, the connection portions 10a-c, 11a-c can be welded in pairs on the insides of the projections 123 to form the electrically conductive and mechanical connection.

In addition, each connection element 114a-c has a securing means 124 for electrically conductively and mechanically connecting the connection portion 122 to an electrical conductor 205 (see FIG. 12). The securing means 124 is designed as a bushing and has an internal thread 125. The securing means 124 is pressed into a passage opening 126 of the connection portion 122. The bushing extends, in particular axially, into an intermediate space 127 delimited by the limb portions 121a, 121b.

FIG. 9 and FIG. 10 show the second isolating body 113, wherein FIG. 9 is a plan view of the first side 116 thereof and FIG. 10 is a detailed perspective view of the positioning portion 120a. FIG. 11 is a detailed perspective view of the second isolating body 113 with the connection element 114a arranged. The arrangement of the connection elements 114a-c on the first isolating body 113 is explained below with reference to the positioning portion 120a and the connection element 114a which is representative of the further positioning portions 120b, 120c and connection elements 114b, 114c.

The positioning portion 120a first comprises a centering element 128 formed on the first side 116. The centering element 128 is divided into two parts and sections thereof are formed in a mirror-inverted manner to the securing means 124 in the form of a bushing. To center the connection element 114a, the securing means 124 is inserted into the centering element 128.

To inhibit a translational movement of the connection element 114a, the positioning portion 120a has for each limb portion a delimiting element 129 extending from the limb portion 121a to the limb portion 121b and stops 130a, 130b, 130c, 130d arranged outside the limb portions 121a, 121b. Here, as an example, two stops 130a-d are provided on each outer side of one of the limb portions 121a, 121b. A rotational movement of the connection element 114a about a rotational axis perpendicular to the base portion 115 may further be inhibited by way of the stops 130a-d. In the present exemplary embodiment, the centering element 128 is partially formed in one piece with the delimiting element 129.

In addition, the positioning portion 120a has for each limb portion 121a, 121b a holding element 131a, 131b which is designed as a latching element in the present case. A movement of the connection element 114a from the first side 116 pointing away or in the axial direction with respect to the longitudinal axis 6 may be inhibited by way of the holding elements 131a, 131b. For this purpose, each limb portion 121a, 121b has a recess 132 (see also FIG. 8) in which the holding element 131a, 131b is positively engaged. As an additional safeguard against the insertion of the connection element 114a into the positioning portion 120a in a manner twisted by 180°, the holding elements 131a, 131b are arranged eccentrically with respect to the corresponding limb portion 121a, 121b.

To extend air and creepage distances between the connection elements 114a-c and/or other electrically conductive components in the vicinity of the connection element 114a-c, the second isolating body 113 also has shielding elements 133a, 133b, 133c, 133d, 133e which surround the respective connection element 114a-c on the limb portion side. In this case, the stops 130a-d are formed in one piece with the shielding elements 133a-e.

Again with reference to FIG. 2 and FIG. 7, the first isolating body 13 initially has two spacers 17 which space the first isolating body 13 apart from the second isolating body 113. As can also be seen in FIG. 2, the first isolating body 13 also has a plurality of securing portions 29a, 29b, 29c, 29d, 29e, 30a, 30b, 30c, 30d which protrude from the base portion 14 in the direction facing the second isolating body 113 and are designed to secure the second isolating body 113 to the first isolating body 13. In this case, the securing portions 29a-e are formed as latching elements which penetrate a passage opening of the base portion 115 of the second isolating body 114 and engage the base portion 115 of the second isolating body 113 for securing on the first side 116. The securing portions 30a-d, on the other hand, are each engaged with a securing means 31, in this case for example a screw, penetrating the base portion 115 of the second isolating body 113.

FIG. 12 shows a schematic diagram of a vehicle 200 having an exemplary embodiment of an electric drive 201.

The electric drive 201 has an electric machine 203 formed from the stator device 1 and a rotor 202 which is mounted so as to be able to rotate with respect to the stator device 1. The electric machine 203 is for example a permanently or electrically excited synchronous machine or an asynchronous machine.

In addition, the electric drive 201 has a converter 204 in the form of an inverter which is designed for the electrical power supply of the stator winding 5 (see FIG. 1). The converter 204 is connected to the stator winding via electrical conductors 205, for example each in the form of a busbar. In this case, each electrical conductor 205 is electrically conductively secured to one of the securing means 24 of one of the connection elements 114a-c (see FIG. 8) such that the electrically conductive connection of the connection portions 10a-c, 11a-c via the connection elements 114a-c to the electrical conductors 205 is formed.

The vehicle 200 furthermore has wheels 206. The electric machine 202 is configured to drive at least one of the wheels 206 indirectly, for example via a gear mechanism (not shown), or directly, for example in the form of a wheel hub motor. The vehicle 200 may also have an axle (not shown) which is coupled to the wheel 206 and which directly or indirectly drives the electric machine 203 of the vehicle 200.

The vehicle 200 is a battery electric vehicle (BEV), a vehicle operated by means of a fuel cell, or a hybrid vehicle. In the latter case, the vehicle 200 also has an internal combustion engine (not shown).

1. A stator device for an electric machine, having:
a stator (3), having a stator core with a longitudinal axis, a first end face and a second end face which is situated axially opposite the first end face with respect to the longitudinal axis, and having a stator winding which forms a winding head on the first end face and has a plurality of connection portions extending beyond the winding head; and
a connection device which has an isolating body which has a plate-shaped base portion with a first side remote from the winding head and a second side facing the winding head and is designed to connect the connection portions to an electrical conductor;
wherein the isolating body has a plurality of holding elements, which protrude from the base portion on the second side and are designed to hold the isolating body radially on the winding head.

2. The stator device as claimed in claim 1, wherein
the holding elements comprise holding elements of a first type which are elastically deformable at least in sections such that they exert a restoring force for holding the isolating body on the winding head.

3. The stator device as claimed in claim 2, wherein
the holding elements comprise holding elements of a second type which are designed to absorb a counterforce of the restoring force.

4. The stator device as claimed in claim 3, wherein
the holding elements of the first and second type are arranged on opposite radial sides of the winding head.

5. The stator device as claimed in claim 2, wherein
the holding elements of the first type each have a frame and elastically deformable tabs formed within the frame which are mounted on the frame and exert the restoring force on the winding head.

6. The stator device as claimed in claim 1, wherein
a plurality of legs which rest on the stator core and position the base portion at a distance from the stator are arranged on the second side of the base portion.

7. The stator device as claimed in claim 1, wherein
the base portion has a plurality of passage openings through which the connection portions are passed.

8. The stator device as claimed in claim 1, wherein
the connection device has a star point conductor and the isolating body has guide elements by way of which a movement of the star point conductor along the longitudinal direction thereof and/or transversely to the longitudinal direction thereof is able to be impeded.

9. The stator device as claimed in claim 1, wherein
the connection device also has:
an electrically isolating second isolating body which has a plate-shaped base portion with a first side and a second side which is situated opposite the first side and facing the first side of the base portion of the first isolating body, and
an electrically conductive connection element which has a securing means for electrically conductive and mechanical connection to the electrical conductor and is arranged on the first side of the second isolating body.

10. The stator device as claimed in claim 9, wherein
the connection element has two limb portions and a connecting portion which connects the two limb portions at least in sections, wherein two connection portions of the stator winding are electrically conductively and mechanically connected to each of the limb portions of one of the connection elements in order to form an electrically conductive connection of the connection portions to the electrical conductor via the connection element.

11. The stator device as claimed in claim 10, wherein
the base portion of the second isolating body has a recess in which the two connection portions are arranged.

12. The stator device as claimed in claim 9, wherein
the first isolating body has a plurality of securing portions which protrude from the base portion of the first isolating body in the direction facing the first isolating body and are designed to secure the second isolating body to the first isolating body.

13. The stator device as claimed in claim 12, wherein
at least some of the securing portions are in the form of a latching element which penetrates a passage opening of the base portion of the second isolating body and engages behind the base portion of the second isolating body in order to secure same on the first side thereof and/or
at least some of the securing portions engage with a securing means, in particular a screw, which penetrates the base portion of the second isolating body.

14. An electric drive for a vehicle, having:
a stator device as claimed in claim 1,
a rotor mounted so as to be able to rotate with respect to the stator device such that the stator device and the rotor form an electric machine,
a converter for the electrical power supply of the stator winding and
the electrical conductor via which the converter is electrically conductively connected to the connection portion.

15. The stator device as claimed in claim 3, wherein
the holding elements of the first type each have a frame and elastically deformable tabs formed within the frame which are mounted on the frame and exert the restoring force on the winding head.

16. The stator device as claimed in claim 2, wherein
a plurality of legs which rest on the stator core and position the base portion at a distance from the stator are arranged on the second side of the base portion.

17. The stator device as claimed in claim 2, wherein
the base portion has a plurality of passage openings through which the connection portions are passed.

18. The stator device as claimed in claim 2, wherein
the connection device has a star point conductor and the isolating body has guide elements by way of which a movement of the star point conductor along the longitudinal direction thereof and/or transversely to the longitudinal direction thereof is able to be impeded.

19. The stator device as claimed in claim 2, wherein
the connection device also has:
an electrically isolating second isolating body which has a plate-shaped base portion with a first side and a second side which is situated opposite the first side and facing the first side of the base portion of the first isolating body, and
an electrically conductive connection element which has a securing means for electrically conductive and mechanical connection to the electrical conductor and is arranged on the first side of the second isolating body.

20. The stator device as claimed in claim 10, wherein
the first isolating body has a plurality of securing portions which protrude from the base portion of the first isolating body in the direction facing the first isolating body and are designed to secure the second isolating body to the first isolating body.
